(19) United States
(12) Patent Application Publication
(10) Pub. No.: US 2020/0274255 A1
(43) Pub. Date: Aug. 27, 2020

(54) Everted Dipole UWB Antenna

(71) Applicant: Elscint Tomography Inc., Petah Tikva (IL)

(72) Inventors: Steve Krupa, Haifa (IL); Alexander Lomes, Moshav Hosen (IL); Shmuel Suhami, Petah Tikva (IL)

(21) Appl. No.: 16/283,775

(22) Filed: Feb. 24, 2019

(51) Int. Cl. H01Q 21/20; H01Q 9/16; H01Q 1/27

(52) U.S. Cl. CPC H01Q 21/20; H01Q 1/2283; H01Q 1/273; H01Q 9/16

(57) ABSTRACT

This invention provides a compact and efficient means to wirelessly transfer wideband electromagnetic signals through a variety of different propagation media, including biological tissues for in vivo applications. The invention demonstrates increased immunity to antenna de-tuning when deployed in challenging near-field electromagnetic (EM) environments, a key advantage for both biomedical and conventional antenna applications.

### FIELD OF THE INVENTION

This invention relates to antennas, generally, and particularly to a family of antenna elements which provide high operating bandwidth and increased immunity to detuning effects arising from conductive, dielectric, and/or biological elements placed within the near-field of the antenna. Said immunity permits assembly of these antennas into closely spaced, compact arrays suitable for various applications, including Multiple Input/Multiple Output (MIMO) wireless transmit/receive operation, high-gain wireless signal transmission over narrow, wideband, or ultrawideband frequency channels, or to provide a focal, non-invasive EM stimulus within the target substrate/tissue for medical applications.

### BACKGROUND OF THE INVENTION

The interaction(s) of antenna elements with their proximal operating environment have always posed a significant challenge to wireless RF and MW engineers. This proximal environment can be loosely defined as the collection of objects (conductors, dielectrics, body parts) placed in the “near-field” region of the antenna, generally defined as a sphere of 2D²/λ, where Lambda is the center frequency of the EM signal and D is the effective aperture length of the antenna. Practically, these conductive, dielectric, or biological objects can perturb the electric and/or magnetic fields surrounding the antenna device as it transmits or receives EM signals, often in a manner which shifts or degrades the range of frequencies which the device was designed to support. This is commonly known as “antenna detuning”, and can be observed whenever multiple antennas are grouped together as an array, or when the antenna directs EM signal energy into a nearby substrate or tissue. Unplanned field perturbations in the near-field can change (“detune”) the effective port impedance of the antenna, causing an impedance mismatch between the antenna and the feed line, resulting in unwanted signal reflections with the transmission line and compromised signal radiation/reception from the antenna This is the phenomena underlying antenna detuning, and is prevalent in antennas characterized by high electric fields at the distal portions of the radiating elements, particularly conventional monopoles and dipoles. In contrast to such antennas, the Everted Dipole provides increased immunity from antenna detuning effects when operated in close proximity to conductive, dielectric, or biological elements.

In summary, the Everted Dipole provides similar toroidal radiation patterns as conventional dipole elements, over much wider operating bandwidths, with a significant immunity to port impedance detuning when operated near other antennas and to objects adjacent to arms of the device.

### BRIEF SUMMARY OF THE INVENTION

The aim of the invention is to reduce the detuning susceptibility of an antenna element to objects placed within the near-field of its radiating arms.

The main claim of the invention is the provision of toroidal radiation patterns, high operating bandwidth and increased immunity to detuning effects when operating the “Everted Dipole” as a balanced antenna device, particularly in the presence of conductive, dielectric, and/or biological elements.

The greatest impact of the “Everted Dipole” device is the facilitation of spatially compact UWB antenna array configurations that would be extremely problematic to realize with conventional antenna elements. The practical benefits of the “Everted Dipole” recommend its deployment as the fundamental antenna element in technically challenging wireless applications, such as:
MIMO based wireless devices Portable UWB radar
Compact UWB beamforming arrays MW Imaging and EM-based therapeutic modalities like RF heating, etc.

This topic will be dealt with, below, in conjunction with FIG. 1, in section “DETAILED DESCRIPTION OF THE PREFERRED EMBODIMENTS” below.

### BRIEF DESCRIPTION OF THE DRAWINGS

FIG. 1 illustrates the general topology of the Everted Dipole

FIG. 2 shows an alternate version of the Everted Dipole, realized as a PCB structure

FIG. 3 depicts the measured Return Loss bandwidth of a 4 GHz Everted Dipole prototype

FIG. 4 shows the Far Field antenna Gain pattern of a “2.5D” (PCB) Everted Dipole.

FIG. 5 shows a conformal array of 4 closely spaced Everted Dipoles, for MW imaging . . .

FIG. 6 depicts a linear array of 4 Everted Dipoles.

FIG. 7 shows a planar array of 3 Everted Dipoles, arranged as an equilateral triangle.

FIG. 8 shows a planar array of 4 Everted Dipoles, arranged as a quadrilateral.

### DETAILED DESCRIPTION OF THE PREFERRED EMBODIMENTS

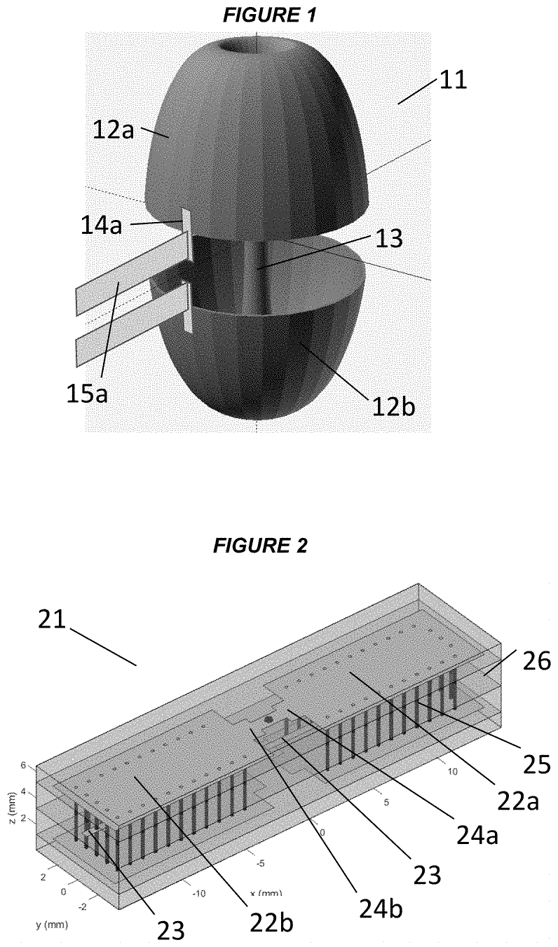

Referring to FIG. 1, the fundamental signal transduction system realized with this invention is comprised of a radio-frequency feedline 15 and the Everted Dipole 11 element itself. FIG. 1 depicts the general topology of the Everted Dipole, defined by a pair of external radiating elements 12a & 12b, connected internally by a central element 13 spanning the width of the device 11. Topologically, it can be viewed as a bilateral, partial eversion of thin tube central element 13, with the everted portions expanded and flared to form the arms 12a & 12b of a dipole radiating element. The central element 13 and the external radiating elements 12a & 12b can be coaxial. In another embodiment, the central element 13 can be arranged off-center. The preferred embodiment of the device can be realized using only a thin sheet of contiguous conductors. Other variants can be fabricated using solid wire for the central element, and filling the internal and external regions surrounding the (hollow) dipole arms with substances of known/controlled dielectric constant (Dk) such as solid PTFE, polyimide sheet, and other materials. A design advantage of the Everted Dipole 11 is the wide-ranging “tunability” of the port impedance, via manipulation of the key design variables: diameter and profile of outer radiating elements 12a & 12b, diameter and profile of central element 12, gap distance between radiating arms 12a & 12b, the dielectric permittivity of the region(s) surrounding the central and external elements, and the overall profile of the dielectric material as it envelopes the conductive elements. This wide-ranging adjustability in the complex port impedance of the Everted dipole facilitates the design of antenna structures capable of UWB operation or narrow band frequency coverage, depending on the ensemble specification of the mentioned design variables and the impedance requirements of the feeding transmission line.

FIG. 2 shows an alternate, laminar “2.5 Dimensional” (2.5D) fabrication method used to realize the topology of the Everted dipole. In this embodiment, the invention is realized as a pair of spatially displaced printed circuit board (PCB) trace layers forming the radiating arms 22a & 22b of the dipole, electrically excited by a wideband signal differentially applied to the medial ends of said radiating arms 22a & 22b at a pair of feed points 24a & 24b. Conductive vias 25 connect these upper and lower trace layers, forming the side walls of the radiating arms 22a & 22b. The central element 23 is a thin contiguous trace element deployed on yet another, intermediate trace layer. This central element 23 is electrically connected at its terminal ends to the radiating arms 22a & 22b with one or more vias 5. The conductive trace portions of the Everted Dipole are conformal to a plurality of bonded substrate layers 26, effectively forming a “sandwich” of interleaved, electrically insulative substrate materials and conductive trace elements. A variety of substrate materials can be used in the fabrication of such an Everted Dipole: common materials might include PTFE-based substrates, epoxy based substrates such as FR-4, high dielectric ceramic-based substrates such as Rogers TMM10, or even low density/low Dk foamed polymer substances. Additionally, analogous fabrication techniques used to realize conductive traces and vias in semiconductor processing would permit the formation of Everted Dipole as integrated elements within a microchip device, enveloped by one of a plurality of possible semiconductor substrates (silicon, germanium, gallium arsenide, etc.).

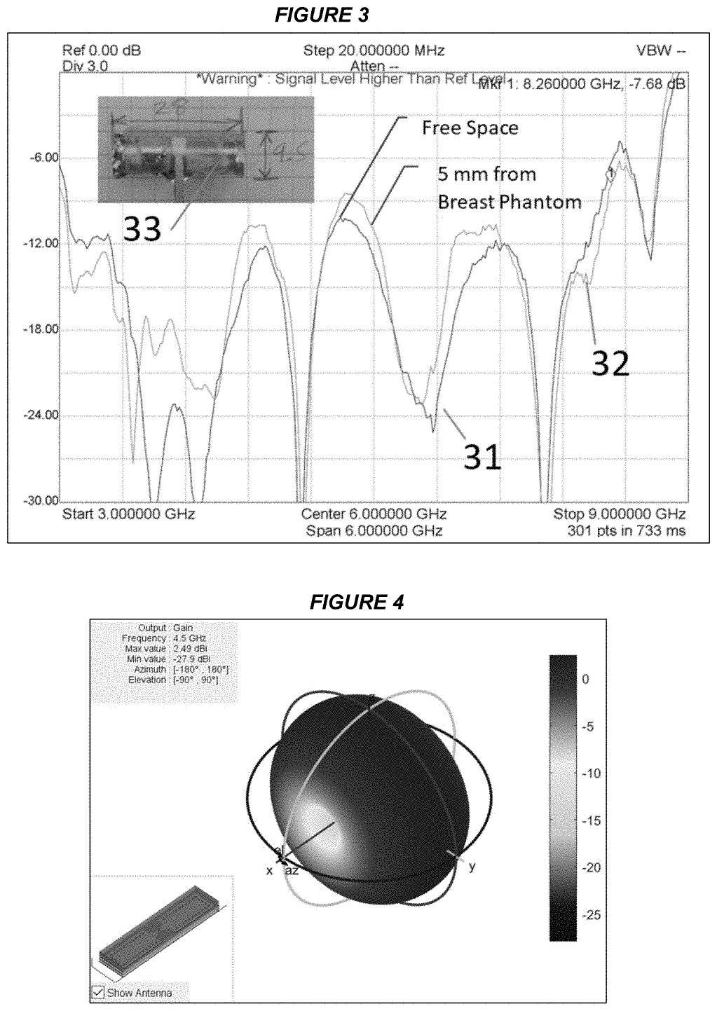

The device is capable of transmitting and receiving wideband RF or microwave signals over bandwidths approaching or exceeding 100%. FIG. 3 shows the impedance match of yet another cylindrical embodiment 33 of the invention, measured as the fractional amplitude of the original signal power reflected by the Everted dipole back towards the transmitter, expressed in decibels and tested over a range of specific frequencies. Using the −6 dB level of reflected signal as the upper (worst-case) limit of acceptable impedance match, the “free space” graph 31 shown in FIG. 3 depicts an operating range spanning the frequencies between 3 GHz and 8.25 GHz. Assuming a center frequency of 6 GHz, the Everted dipole sample used to generate the FIG. 3 graphs provides 87.5% bandwidth. With respect to the lower frequency bound of the signal (3 GHz, as in FIG. 3), the device is compact in size. A typical half-wave resonant dipole tuned for 3 GHz operation requires a length of approximately 5 cm. The Everted Dipole 33 characterized by the graphs 31 & 32 measures only 2.8 cm in length, and covers a much wider bandwidth than said resonant dipole.

Functionally, the Everted Dipole 11 shown in FIG. 1 converts the bound wideband signal conveyed by the transmission line 15a & 15b into a divergent electromagnetic field configuration which can be freely radiated into free space or coupled into a proximal target substrate/element, as a near-field transducer. To validate operation of the Everted dipole as a free space antenna, FIG. 4 depicts the far-field gain pattern 41 radiated by a “2.5D” version 42 of the invention, realized as a multi-layer printed circuit board (PCB) design. The graph shown in this Figure exemplifies the well-known toroidal Gain pattern plots normally associated with resonant dipole radiators, providing a spatial distribution of radiated signal power that is both ubiquitous and advantageous in the domain of wireless system design.

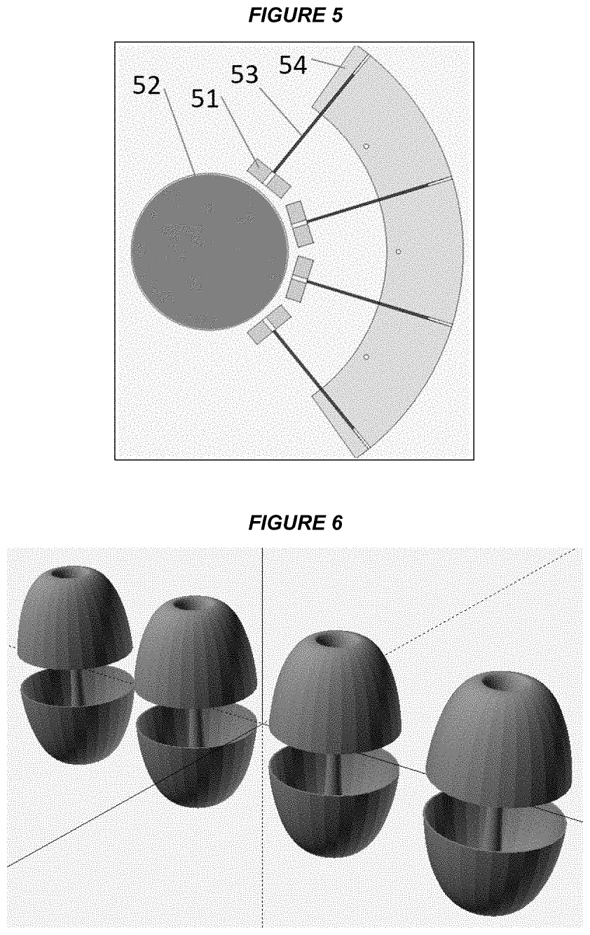

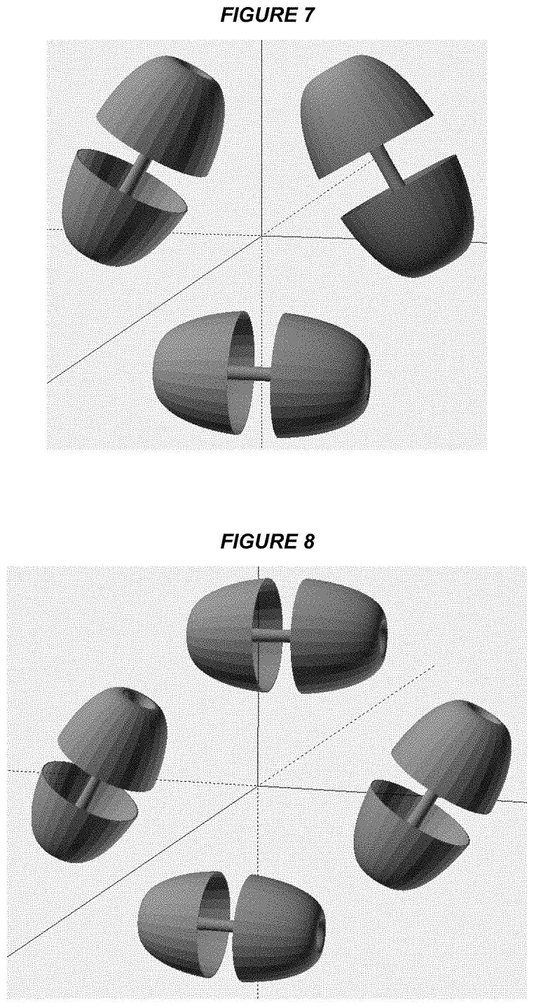

A key advantage of the invention is an increased immunity of the device to deleterious near-field coupling between the radiating arms and adjacent objects within the near-field zone, a common problem observed with conventional dipole radiators/transducers. This feature allows the device to be easily deployed in various compact array configurations as drawn in FIGS. 5 through 9 without the usual (severe) port impedance detuning effects commonly encountered in these spatial arrangements with conventional dipole antennas. The graphs 31 & 32 in FIG. 3 exemplify this de-tuning immunity, demonstrating only marginal changes in port impedance when the Everted Dipole 33 is spatially re-oriented from the free space operating condition of graph 31 to close-proximity near-field coupling of the same microwave signal into a size and Dk-matched tissue phantom, shown in graph 32.

There are multiple ways to realize the invention explained above, combining the differentiating features illustrated in the accompanying figures, and devising new embodiments of the method described, without departing from the scope and spirit of the present invention. Those skilled in the art will recognize that other embodiments and modifications are possible. While the invention has been described with respect to the preferred embodiments thereof, it will be understood by those skilled in the art that changes may be made in the above constructions and in the foregoing sequences of operation without departing substantially from the scope and spirit of the invention. All such changes, combinations, modifications, and variations are intended to be included herein within the scope of the present invention, as defined by the claims. It is accordingly intended that all matter contained in the above description or shown in the accompanying figures be interpreted as illustrative rather than in a limiting sense.

1. An antenna designed for operation above 1.5 GHz, comprising a pair of spatially removed external radiating elements, connected distally to and partially surrounding an internal central element, with additional medial connections between the external radiating elements and the terminal connections of an RF transmission line; wherein the length, profile and diameter of the external elements and the length, profile, and diameter of the central element are selected to provide at least one of a reflection coefficient less than 25% and radiation efficiency exceeding −5 dB (31.6%) when operated as a free space antenna over a selected (nominally wide) frequency range.

2. An antenna according to claim 1, wherein the internal and external regions surrounding the external elements and central element are filled with substances of deliberately selected loss tangent and dielectric constant (Dk) (ONE of: solid PTFE, polyimide sheet, or foamed polymer).

3. An antenna according to claim 1, wherein the internal and external regions surrounding the external elements and central element are filled with substances of deliberately selected loss tangent and dielectric constant (Dk) (ONE of: solid PTFE, polyimide sheet, or foamed polymer), with the dielectric constants and profile of the enveloping material substances selected to provide at least one of a reflection coefficient less than 25% and radiation efficiency exceeding −5 dB (31.6%) when operated as a free space antenna over a selected frequency range of interest.

4. An antenna according to claim 1, wherein the external radiating elements are realized as a pair of upper and lower planar conductive traces joined by a series of perpendicular cylindrical conductive interconnects (vias) and the central element is fabricated as a planar conductive trace element interposed between and distally connected to the conductive traces comprising the external elements by way of 2 or more conducting vias, and the conductive external and central elements are conformal to a plurality of bonded substrate layers forming a “sandwich” of interleaved, electrically insulative substrate materials and conductive trace elements, fabricated as a multi-layer printed circuit board (PCB) or as an integrated component enveloped by semiconductor substrate as part of a microchip device.

5. An assembly of antennas as in claim 1, wherein the antenna elements are arranged along an open path (one of a line or a curve or combination of these elements) as an array for the purposes of beamforming or beam steering or for operation as independent, spatially diverse antenna devices in a MIMO-based transceiver system.

6. An assembly of antennas as in claim 1, wherein the antenna elements are arranged along a closed polygon path (one of a triangle or quadrilateral or combination of these elements) as an array for the purposes of beamforming or beam steering or for operation as independent, spatially diverse antenna devices in a MIMO-based transceiver system.

7. An assembly of antennas as in claim 1, wherein the antenna elements are situated in a conformal manner about a sample of living tissue or other material substrate for the purposes of beamforming or beam steering or for operation as independent, spatially and polarization diverse antenna devices in a MIMO-based transceiver system, where the intended direction of signal propagation is outward from the tissue sample or material substrate.

8. An assembly of antennas as in claim 1, wherein the internal and external regions surrounding the external elements and central elements are filled with substances of deliberately selected loss tangent and dielectric constant (Dk) (ONE of: solid PTFE, polyimide sheet, or foamed polymer), with the dielectric constants and profile of the enveloping material substances selected to provide at least one of a reflection coefficient less than 25% and radiation efficiency exceeding −5 dB (31.6%) when collectively operated as a free space antenna array over a selected frequency range of interest, and the antenna elements are arranged along an open path (one of a line or a curve or combination of these elements) for the purposes of beamforming or beam steering or for operation as independent, spatially diverse antenna devices in a MIMO-based transceiver system.

9. An assembly of antennas as in claim 1, wherein the internal and external regions surrounding the external elements and central elements are filled with substances of deliberately selected loss tangent and dielectric constant (Dk) (ONE of: solid PTFE, polyimide sheet, or foamed polymer) with the dielectric constants and profile of the enveloping material substances selected to provide at least one of a reflection coefficient less than 25% and radiation efficiency exceeding −5 dB (31.6%) when collectively operated as a free space antenna array over a selected frequency range of interest, and the antenna elements are arranged along a closed polygon path (one of a triangle or quadrilateral or combination of these elements) for the purposes of beamforming or beam steering or for operation as independent, spatially diverse antenna devices in a MIMO-based transceiver system.

10. An assembly of antennas as in claim 1, wherein the internal and external regions surrounding the external elements and central elements are filled with substances of deliberately selected loss tangent and dielectric constant (Dk) (ONE of: solid PTFE, polyimide sheet, or foamed polymer), with the dielectric constants and profile of the enveloping material substances selected to provide at least one of a reflection coefficient less than 25% and radiation efficiency exceeding −5 dB (31.6%) when collectively operated as a transducer array over a selected frequency range of interest, and the transducer elements are situated in a conformal manner about a sample of living tissue or other material substrate for the purposes of beamforming or beam steering or for operation as independent, spatially and polarization diverse antenna devices in a MIMO-based transceiver system where the intended direction of signal propagation is outward from the tissue sample or material substrate.

11. A transducer designed for operation above 300 MHz, comprising a pair of spatially removed external radiating elements, connected distally to and partially surrounding an internal central element, with additional medial connections between the external radiating elements and the terminal connections of an RF transmission line; wherein the length, profile and diameter of the external elements and the length, profile, and diameter of the central element are selected to provide at least one of a reflection coefficient less than 25% and transmission efficiency exceeding −60 dB when operated as a near-field transducer deployed in close proximity to living tissue and other material substrates, over a selected (nominally wide) frequency range of interest.

12. A transducer according to claim 11, wherein the internal and external regions surrounding the external elements and central element are filled with substances of deliberately selected loss tangent and dielectric constant (Dk) (ONE of: solid PTFE, polyimide sheet, or polymer foam), with the dielectric constants and profile of the enveloping material substances selected to provide at least one of a reflection coefficient less than 25% and transmission efficiency exceeding −60 dB operated as a near-field transducer deployed in close proximity to living tissue and other material substrates, over a selected (nominally wide) frequency range of interest.

13. A transducer according to claim 11, wherein the external radiating elements are realized as a pair of upper and lower planar conductive traces joined by a series of perpendicular cylindrical conductive interconnects (vias) and the central element is fabricated as a planar conductive trace element interposed between and distally connected to the conductive traces comprising the external elements by way of 2 or more conducting vias, and the conductive external and central elements are conformal to a plurality of bonded substrate layers forming a “sandwich” of interleaved, electrically insulative substrate materials and conductive trace elements, fabricated as a multi-layer printed circuit board (PCB) or as an integrated transducer component enveloped by semiconductor substrate as part of a microchip device.

14. An assembly of transducers as in claim 11, wherein the transducer elements are arranged along an open path (one of a line or a curve or combination of these elements) as an array for the purposes of beamforming or beam steering or for operation as independent, spatially diverse transducer devices in a MIMO-based transceiver system.

15. An assembly of transducers as in claim 11, wherein the transducer elements are arranged along a closed polygon path (one of a triangle or quadrilateral or combination of these elements) as an array for the purposes of beamforming or beam steering or for operation as independent, spatially diverse transducer devices in a MIMO-based transceiver system.

16. An assembly of transducers as in claim 11, wherein the transducer elements are situated in a conformal manner about a sample of living tissue or other material substrate for the purposes of beamforming or beam steering or for operation as independent, spatially and polarization diverse transducer devices in a MIMO-based transceiver system where the direction of signal propagation is inward (medial) to the tissue sample or material substrate.

17. An assembly of transducers as in claim 11, wherein the internal and external regions surrounding the external elements and central elements are filled with substances of deliberately selected loss tangent and dielectric constant (Dk) (ONE of: solid PTFE, polyimide sheet, or foamed polymer), with the dielectric constants and profile of the enveloping material substances selected to provide at least one of a reflection coefficient less than 25% and transmission efficiency exceeding −60 dB when collectively operated as a transducer antenna array over a selected frequency range of interest, and the transducer elements are arranged along an open path (one of a line or a curve or combination of these elements) for the purposes of beamforming or beam steering or for operation as independent, spatially diverse transducer devices in a MIMO-based transceiver system.

18. An assembly of transducers as in claim 11, wherein the internal and external regions surrounding the external elements and central elements are filled with substances of deliberately selected loss tangent and dielectric constant (Dk) (ONE of: solid PTFE, polyimide sheet, or foamed polymer), with the dielectric constants and profile of the enveloping material substances selected to provide at least one of a reflection coefficient less than 25% and transmission efficiency exceeding −60 dB when collectively operated as a transducer array over a selected frequency range of interest, and the transducer elements are arranged along a closed polygon path (one of a triangle or quadrilateral or combination of these elements) for the purposes of beamforming or beam steering or for operation as independent, spatially diverse transducer devices in a MIMO-based transceiver system.

19. An assembly of transducers as in claim 11, wherein the internal and external regions surrounding the external elements and central elements are filled with substances of deliberately selected loss tangent and dielectric constant (Dk) (ONE of: solid PTFE, polyimide sheet, and other materials), with the dielectric constants and profile of the enveloping material substances selected to provide at least one of a reflection coefficient less than 25% and transmission efficiency exceeding −60 dB when collectively operated as a transducer array over a selected frequency range of interest, and the transducer elements are situated in a conformal manner about a sample of living tissue or other material substrate for the purposes of beamforming or beam steering or for operation as independent, spatially and polarization diverse transducer devices in a MIMO-based transceiver system where the direction of signal propagation is inward (medial) to the tissue sample or material substrate.
